(19) United States
(12) Patent Application Publication
(10) Pub. No.: US 2004/0178681 A1
(43) Pub. Date: Sep. 16, 2004

(54) System for providing backup power to an electronic device

(75) Inventor: Colin F. Klenner, Maupuia (NZ)

Correspondence Address: DOCKET CLERK, DM/EDS, P.O. DRAWER 800889, DALLAS, TX, 75380, US

(73) Assignee: ELECTRONIC DATA SYSTEMS CORPORATION, PLANO, TX

(21) Appl. No.: 10/386,120

(22) Filed: Mar. 11, 2003

(51) Int. Cl. H02J 7/00

(52) U.S. Cl. 307/66

(57) ABSTRACT

A system for providing backup power to essential system elements in the event of a power failure. According to this embodiment, a failure detection circuit and capacitance storage are connected to the power inputs of essential system circuit boards, in line with the standard direct-current (DC) power source. The DC source maintains the charge of the capacitance storage, and when a failure is detected, the capacitors discharge to maintain stable DC power input to the system circuit boards. In the preferred embodiment, at least 30 seconds of backup power is available when needed.

### TECHNICAL FIELD OF THE INVENTION

The present invention is directed, in general, to power systems in electronic devices.

### BACKGROUND OF THE INVENTION

Power supplies to integrated circuits, random-access memory boards, and digital processors require tight conformation of specifications for variability of supply of electrical current, expressed in volts, amps, and watts. Generally, unless a device is specifically protected, a slight reduction or excessive peak of voltage will cause the instructions temporarily stored in the electronic device at the time to be lost, resulting in the device requiring restarting and/or reprogramming from a powered-off state.

Attempts to remedy the situation have focused on ensuring the power supply to the device is externally monitored, and a backup storage device, usually a battery, is integrated into the external power feed. These external devices deal with the total power supply for the device and its peripheral components, and allow provision for power outages lasting several minutes upwards. They generally, although not always, filter and monitor alternating current (AC) supplies of electricity. Larger versions of these external devices incorporate uninterruptible power supply (UPS) technology, generator capacity, -and energy-storage devices (batteries). They tend to be bulky and expensive to purchase, operate and maintain.

Power supplies in most areas of the world are prone to interference from natural and man-made causes. Electrical grid managers have installed large-scale redundancy systems to ensure interruptions to nominal supply are minimized at the grid-level. However local variations to the current caused by local events do create brown-out and occasionally short breaks in power supply. Typically, these localized events last from a few milliseconds up to several minutes or more. Installing UPS devices for these random events is costly in purchase and maintenance terms.

There is, therefore, a need in the art for a system for providing a stable backup power source for electronic devices.

### SUMMARY OF THE INVENTION

To address the above-discussed deficiencies of the prior art, it is a primary object of the present invention to provide an improved and inexpensive backup power source for electronic devices.

The preferred embodiment provides a system for providing backup power to essential system elements in the event of a power failure. According to this embodiment, a failure detection circuit and capacitance storage are connected to the power inputs of essential system circuit boards, in line with the standard direct-current (DC) power source. The DC source maintains the charge of the capacitance storage, and when a failure is detected, the capacitors discharge to maintain stable DC power input to the system circuit boards. In the preferred embodiment, at least 30 seconds of backup power is available when needed.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a system in accordance with a preferred embodiment of the present invention; and

FIG. 2 depicts a block diagram of a system in accordance with an alternate embodiment of the present invention.

### DETAILED DESCRIPTION OF THE INVENTION

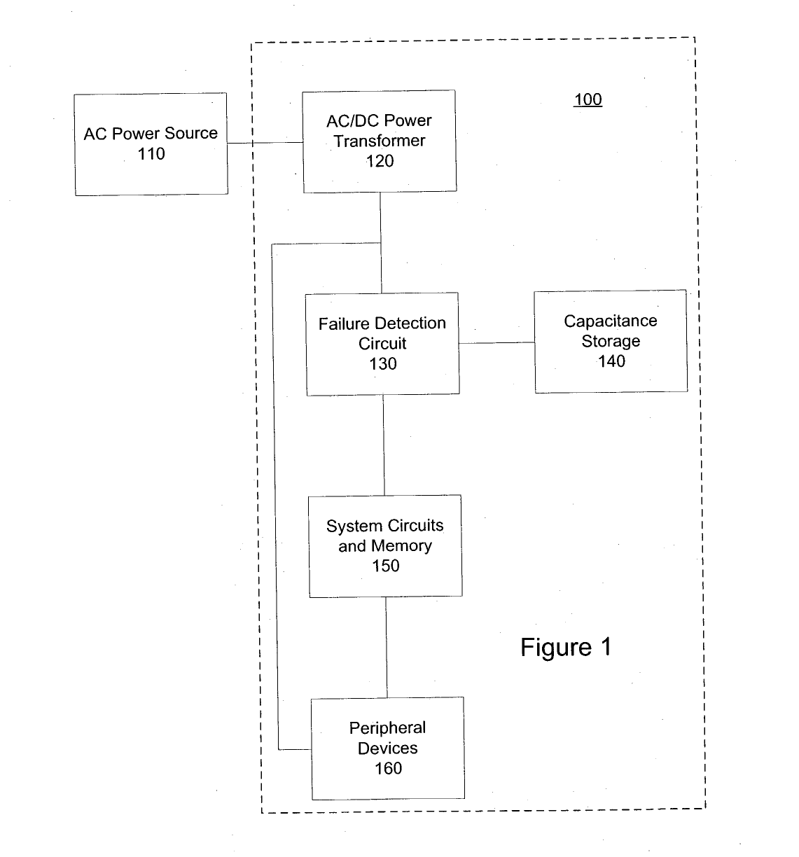

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment provides a system for providing backup power to essential system elements in the event of a power failure. According to this embodiment, a failure detection circuit and capacitance storage are connected to the power inputs of essential system circuit boards, in line with the standard direct-current (DC) power source. The DC source maintains the charge of the capacitance storage, and when a failure is detected, the capacitors discharge to maintain stable DC power input to the system circuit boards. In the preferred embodiment, at least 30 seconds of backup power is available when needed.

Typical electronic devices use digital processors to manage and translate data stored in electronic memory banks, read from and written out to other devices. This core of circuitry requires a constant supply of electrical current, usually in Direct Current (DC) form at 3 volts, 5.5 volts, and 12 volts. Some devices use lower voltages, although these are generally supplied via a step-down process in the circuitry boards on which they reside. Any variation to the voltage causes the contents of the processor and memory banks to be destroyed, causing the device to require a restart, or reprogramming.

Typically the input power from the power grid to the device is in alternating current (AC) form and requires a power transformer to convert the current to direct current (DC) form and step it down to the correct voltage before it is supplied to the circuit boards. This is supplied through discrete wiring to parts of the electronic circuit board holding the digital processor and memory banks. In addition the power supply provides power to other peripheral devices such as the screen, disk storage devices, sound or video cards, and the like.

The preferred embodiment of the present invention incorporates in-line capacitance devices capable of providing the required DC voltage for periods up to 30 seconds to the circuit boards essential elements. The in-line devices receive power from the input power transformer, after transformation to DC power appropriate to that line, and store it as a capacitance charge by being inserted into the DC power feed lines from the power supply.

While the DC flow from the power supply is above the capacitor nominal level the capacitor maintains its charge. When supply drops below nominal level the charge from the capacitor or capacitance storage is discharged into the power line, sustaining DC power at the nominal level until either the capacitor was fully discharged or nominal external power restored. In the preferred embodiment, the capacitance storage comprises one or more capacitors. Power levels to critical parts of the device, such as memory banks and processors, would continue to receive power without interruption through this capacitance supply.

The voltages supplied by the capacitor bank are the same as those of the power source being replaced, and can be 3V, 5.5V, 12V, or other voltages as required.

Most devices tolerate loss of peripheral connectivity, either through hardware detection or software timeout. In the event described above there would be a temporary loss of connectivity to peripheral devices as they went into a no-power state. Since the central services are not interrupted recovery time of the software or application would not be required, although recovery of peripheral devices generally will require a wait period as they reach powered-on state after the loss of power.

In addition to the capacitance charge devices, the preferred embodiment provides that a small failure detection circuit containing input variation detection monitors for the input power. If an unintentional reduction is detected the circuit board switches power to capacitor supply only until external AC power supply is restored. On restoration of AC power supply, the circuit board switches power supply back to the external feed lines, allowing the capacitance device to recover stored charge, and the device to continue functioning without interruption.

Alternately, the system of the preferred invention can be used in conjunction with conventional UPS systems, and will maintain constant power to critical system elements until the UPS can engage to power both the critical systems and necessary support peripherals. This combination will allow both constant power to the essential system elements, until UPS power is available, and then the ability to make an orderly shutdown on UPS power.

FIG. 1 shows a block diagram of a system in accordance with the preferred embodiment. Here, AC power source 110 provides power to data processing system 100. The AC power from power source 110 is converted for use in AC/DC power transformer 120.

Appropriate DC outputs of the AC/DC power transformer 120 are connected directly to peripheral devices 160. Further, appropriate DC outputs of the AC/DC power transformer 120 are connected to the failure detection circuit 130. The DC power from AC/DC power transformer 120, in normal use, is passed through the failure detection circuit 130 to the system circuits and memory 150.

Appropriate portions of the system circuits and memory 150, as known to those of skill in the art, are connected to communicate with (but not to provide power to) peripheral devices 160.

Capacitance storage 140 is kept charged by the DC power from the AC/DC power transformer 120 through failure detection circuit 130. When the failure detection circuit 130 detects that the power from AC/DV power transformer 120 has failed, it forces the discharge of capacitance storage 140. As capacitance storage 140 discharges, it supplies DC power to system circuits and memory 150 through failure detection circuit 130. In this manner, system circuits and memory 150 remain operational.

When failure detection circuit 130 determines that power has been restored, it resumes delivering power to system circuits and memory 150 from AC/DC power transformer 120, and at the same time recharges capacitance storage 140.

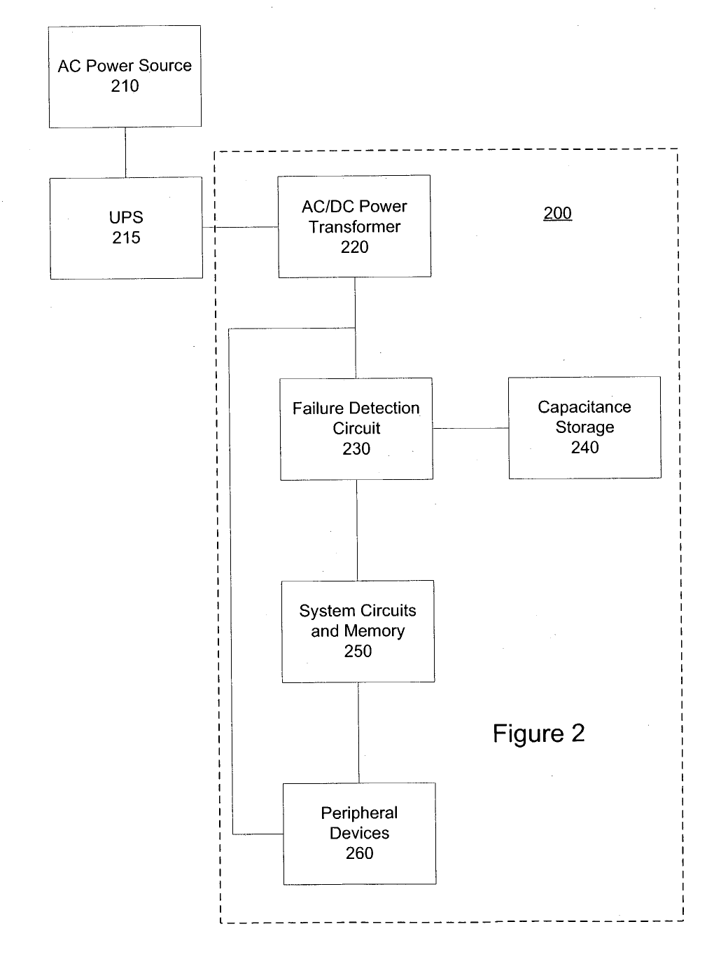

FIG. 2 shows a block diagram of a system in accordance with an alternate embodiment. Much of this embodiment is similar to the preferred embodiment of FIG. 1.

Here, AC power source 210 provides power to data processing system 200. The AC power from power source 210 is passed through uninterruptible power supply (UPS) 215, then is converted for use in AC/DC power transformer 220.

Appropriate DC outputs of the AC/DC power transformer 220 are connected directly to peripheral devices 260. Further, appropriate DC outputs of the AC/DC power transformer 220 are connected to the failure detection circuit 230. The DC power from AC/DC power transformer 220, in normal use, is passed through the failure detection circuit 230 to the system circuits and memory 250.

Appropriate portions of the system circuits and memory 250, as known to those of skill in the art, are connected to communicate with (but not to provide power to) peripheral devices 260.

Capacitance storage 240 is kept charged by the DC power from the AC/DC power transformer 220 through failure detection circuit 230. When the failure detection circuit 230 detects that the power from AC/DC power transformer 220 has failed, it forces the discharge of capacitance storage 240. As capacitance storage 240 discharges, it supplies DC power to system circuits and memory 250 through failure detection circuit 230. In this manner, system circuits and memory 250 remain operational.

At this time, the UPS 115 will engage, and supply power to the AC/DC power transformer 220. It should be noted that failure detection circuit 230 and capacitance storage 240 can generally engage much faster than UPS 215 can, thereby making it much more likely that data and operations in the data processing system will be protected.

When failure detection circuit 230 determines that power has been restored, it resumes delivering power to system circuits and memory 250 from AC/DC power transformer 220, and at the same time recharges capacitance storage 240.

One advantage of this embodiment is that it can protect the data processing system against short-duration faults in its own AC/DC power transformer, wherein a UPS will only protect against failures in the AC power source.

The capacitance storage of the disclosed embodiments can include a bank of capacitors, a single capacitor, or other known energy storage devices, and those of skill in the art will recognize that known voltage-regulating circuits, voltage dividers, stabilizers, or other known power-control circuits can be implemented as necessary to meet the requirements of the specific data processing system. In particular, some embodiments provide for voltage-regulating circuitry to ensure that the power to the system circuits and memory remains constant as the capacitance storage is discharged.

Those skilled in the art will recognize that, for simplicity and clarity, the full structure and operation of all data processing systems and other described circuits and structures suitable for use with the present invention is not being depicted or described herein. Instead, only so much of a data processing system as is unique to the present invention or necessary for an understanding of the present invention is depicted and described. The remainder of the construction and operation of data processing system 100 and other described circuits and structures may conform to any of the various current implementations and practices known in the art.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. An apparatus for providing backup power to an integrated circuit device, comprising:
an integrated circuit;
a power supply connected to provide power to the integrated circuit;
a failure detection circuit connected to receive power from the power supply; and
a capacitance storage connected to provide power to the integrated circuit and to receive power from the power supply, wherein
when the power supply is operating correctly, the capacitance storage receives power from the power supply, and
when the failure detection circuit detects that the power supply is not operating correctly, the capacitance storage provides power to the integrated circuit.

2. The apparatus of claim 1, wherein the integrated circuit includes a processor.

3. The apparatus of claim 1, wherein the integrated circuit includes a volatile memory.

4. The apparatus of claim 1, further comprising an uninterruptible power supply connected to the power supply.

5. The apparatus of claim 1, wherein the capacitance storage includes multiple capacitors.

6. The apparatus of claim 1, wherein the failure detection circuit includes a voltage-regulating circuit.

7. The apparatus of claim 1, wherein the capacitance storage can provide power for at least 30 seconds.

8. The apparatus of claim 1, wherein failure detection circuit includes a regulating circuit to provide constant power as the capacitance storage is discharged.

9. The apparatus of claim 1, wherein the failure detection circuit is not activated on an intentional power-down.

10. The apparatus of claim 1, wherein the capacitance storage provides multiple voltage output levels.

11. A data processing system, comprising:
an integrated circuit;
a power supply connected to provide power to the integrated circuit;
a failure detection circuit connected to receive power from the power supply; and
a capacitance storage connected to provide power to the integrated circuit and to receive power from the power supply, wherein
when the power supply is operating correctly, the capacitance storage receives power from the power supply, and
when the failure detection circuit detects that the power supply is not operating correctly, the capacitance storage provides power to the integrated circuit.

12. The data processing system of claim 11, wherein the integrated circuit includes a processor.

13. The data processing system of claim 11, wherein the integrated circuit includes a volatile memory.

14. The data processing system of claim 11, wherein the power supply is connected to an uninterruptible power supply.

15. The data processing system of claim 11, wherein the capacitance storage includes multiple capacitors.

16. The data processing system of claim 11, wherein the failure detection circuit includes a voltage-regulating circuit.

17. The data processing system of claim 11, wherein the capacitance storage can provide power for at least 30 seconds.

18. The data processing system of claim 11, wherein failure detection circuit includes a regulating circuit to provide constant power as the capacitance storage is discharged.

19. The data processing system of claim 11, wherein the failure detection circuit is not activated on an intentional power-down.

20. The data processing system of claim 11, wherein the capacitance storage provides multiple voltage output levels.
